(19) United States
(12) Patent Application Publication
(10) Pub. No.: US 2026/0219528 A1
(43) Pub. Date: Jul. 30, 2026

(54) DISPLAY APPARATUS

(71) Applicant: LG Display Co., Ltd., Seoul (KR)

(72) Inventors: Dae Hyun NAM, Paju-si (KR); Hyung Beom SHIN, Paju-si (KR); Se Eung LEE, Paju-si (KR); Seong Jun CHO, Paju-si (KR); Chan Ho LEE, Paju-si (KR)

(73) Assignee: LG Display Co., Ltd., Seoul (KR)

(21) Appl. No.: 19/423,770

(22) Filed: Dec. 17, 2025

(30) Foreign Application Priority Data
Jan. 24, 2025 (KR) 10-2025-0011508

(51) Int. Cl. G02F 1/1335; G02F 1/1333; G02F 1/1368

(52) U.S. Cl. CPC G02F 1/133512; G02F 1/133357; G02F 1/1368

(57) ABSTRACT

A display apparatus in which pressure mark inspection is possible on a liquid crystal display panel having a TOB or TOC structure, is discussed. The display apparatus can include a substrate having a display area and a non-display area and including a pad portion provided on a back surface of the substrate in the non-display area, a black matrix disposed on the back surface of the substrate in the non-display area to cover the pad portion, and a flexible printed circuit board pressed against the pad portion. The black matrix includes at least one through hole or at least one area with a reduced thickness configured to inspect a pressure mark caused by pressing the flexible printed circuit board against the pad portion.

### CROSS-REFERENCE TO RELATED APPLICATIONS

This application claims priority to Korean Patent Application No. 10-2025-0011508, filed in the Republic of Korea on Jan. 24, 2025, which is hereby expressly incorporated by reference as if fully set forth herein.

### BACKGROUND OF THE DISCLOSURE

### Field of the Disclosure

The present disclosure relates to a display apparatus, and more particularly, to a display apparatus in which pressure mark inspection is possible.

### Discussion of the Related Art

A video display apparatus that displays various information on a screen is core technology of the information and communication age and is evolving toward being thinner, lighter, more portable, and higher performance. Accordingly, a display apparatus that can be manufactured in a lightweight and thin form is receiving attention.

Specific examples of such a display apparatus include a liquid crystal display (LCD) apparatus, a quantum dot (QD) display apparatus, a field emission display (FED) apparatus, and an organic light emitting diode (OLED) display apparatus.

Among the display apparatuses described above, the liquid crystal display apparatus is configured to include a liquid crystal display panel in which a liquid crystal layer is interposed between a thin film transistor array substrate and a color filter array substrate, and a backlight unit that supplies light to the liquid crystal display panel. Such a liquid crystal display apparatus is driven using the optical anisotropy and polarization properties of liquid crystals. Liquid crystals have a molecular orientation due to a thin and long structure thereof, and the orientation of the liquid crystal molecules can be controlled by artificially applying an electric field to the liquid crystals. By arbitrarily controlling the orientation of the liquid crystal molecules, the alignment of the liquid crystal molecules can be changed, and the transmittance of light supplied from the backlight unit can be controlled, displaying an image through the color filter array. In this way, in order to control the transmittance of light supplied from the backlight unit, a printed circuit board (PCB) configured to apply a driving signal for controlling light transmittance is attached to a pad area of the thin film transistor array substrate.

Recently, in order to minimize a bezel area, a flip liquid crystal display panel in which the color filter array substrate is disposed at the backlight unit side and an image is displayed through the thin film transistor array substrate is being developed.

In the structure of such a flip liquid crystal display panel, a metal wiring in the bezel area can be exposed and visible from a user's side. In order to prevent the metal wiring in the bezel area from being exposed and visible, a bezel printing process can be performed by applying a black pigment onto the bezel area followed by curing, so that a black matrix can be formed in the bezel area.

Further, to reduce reflectance and improve reflective visibility in the structure of the flip liquid crystal display panel, a method of completing a thin film transistor (TFT) array substrate by forming a black matrix (BM) on a substrate and forming a thin film transistor array on the black matrix (TFT on BM, also referred to herein as TOB) and a method of forming a color filter array and a thin film transistor array on a single substrate (TFT on color, also referred to herein as TOC) have been proposed.

However, in the liquid crystal display panel having the TOB or TOC structure described above, the thin film transistor array is formed on the black matrix, making it impossible or difficult to perform pressure mark inspection to determine whether a flexible printed circuit board (FPCB) is correctly attached after attachment of the flexible printed circuit board (FPCB) configured to apply a driving signal to the pad area of the thin film transistor array substrate.

Specifically, the thin film transistor array and a pad portion are formed on the black matrix, and an anisotropic conductive film (ACF) is located between the pad of the thin film transistor array substrate and the flexible printed circuit board (FPCB) and pressed to thus attach the flexible printed circuit board (FPCB) to the pad of the thin film transistor array substrate. Further, in order to determine whether the flexible printed circuit board (FPCB) is correctly attached to the pad of the thin film transistor array substrate, pressure mark inspection is conducted externally using a microscope or camera. However, since the pad area of the thin film transistor array substrate is covered by the black matrix, pressure mark inspection can be impossible or challenging.

### SUMMARY OF THE DISCLOSURE

An object of the present disclosure is to provide a display apparatus in which pressure mark inspection is possible even on a liquid crystal display panel having a TOB or TOC structure.

The objects of the present disclosure are not limited to the foregoing, and other objects not mentioned herein will be clearly understood by those skilled in the art from the following description.

An embodiment of the present disclosure provides a display apparatus, including a substrate having a display area and a non-display area and including a pad portion provided on a back surface of the substrate in the non-display area, a black matrix disposed on the back surface of the substrate in the non-display area to cover the pad portion, and a flexible printed circuit board pressed against the pad portion, in which the black matrix includes at least one through hole or at least one area with a reduced thickness configured to inspect a pressure mark caused by pressing the flexible printed circuit board against the pad portion.

Another embodiment of the present disclosure provides a display apparatus, including a first substrate with a display area and a non-display area defined thereon, a first black matrix disposed on the first substrate in the non-display area, a first planarization layer disposed on the first substrate including the first black matrix, a thin film transistor disposed on the first planarization layer in the display area, a pad portion disposed on the first planarization layer in the non-display area so as to be covered by the black matrix, a second planarization layer disposed on the first substrate on which the thin film transistor in the display area is disposed, a pixel electrode disposed on the second planarization layer and electrically connected to the thin film transistor, a first alignment film disposed on the pixel electrode, a second black matrix and a color filter disposed on a second substrate, a second alignment film disposed on the second substrate on which the second black matrix and the color filter are disposed, a sealant configured to bond the first substrate and the second substrate so that the first alignment film and the second alignment film face each other, a liquid crystal layer interposed between the first substrate and the second substrate, which are bonded, and a flexible printed circuit board attached to the pad portion using a conductive film (for example, an anisotropic conductive film, but not limited thereto), in which the first black matrix has at least one through hole or at least one area with a reduced thickness formed at a location corresponding to the pad portion to inspect a pressed mark caused by pressing the flexible printed circuit board against the pad portion.

Still another embodiment of the present disclosure provides a display apparatus, including a first substrate with a display area and a non-display area defined thereon, a black matrix disposed on the first substrate in the non-display area and the display area, and a color filter disposed on the first substrate in the display area, a first planarization layer disposed on the first substrate including the first black matrix and the color filter, a thin film transistor disposed on the first planarization layer in the display area, a pad portion disposed on the first planarization layer in the non-display area so as to be covered by the black matrix, a second planarization layer disposed on the first substrate on which the thin film transistor in the display area is disposed, a pixel electrode disposed on the second planarization layer and electrically connected to the thin film transistor, a first alignment film disposed on the pixel electrode, a second alignment film disposed on a second substrate, a sealant configured to bond the first substrate and the second substrate so that the first alignment film and the second alignment film face each other, a liquid crystal layer interposed between the first substrate and the second substrate, which are bonded, and a flexible printed circuit board attached to the pad portion using a conductive film (for example, an anisotropic conductive film, but not limited thereto), in which the black matrix has at least one through hole or at least one area with a reduced thickness formed at a location corresponding to the pad portion to inspect a pressed mark caused by pressing the flexible printed circuit board against the pad portion.

Specific details of other embodiments of the present disclosure are included in the detailed description and drawings.

### BRIEF DESCRIPTION OF THE DRAWINGS

The accompanying drawings, which are included to provide a further understanding of the disclosure and are incorporated in and constitute a part of this application, illustrate embodiments of the disclosure and together with the description serve to explain the principle of the disclosure. In the drawings:

FIGS. 1A and 1B are plan views schematically and respectively showing the front surface and the back surface of a display apparatus according to an embodiment of the present disclosure;

FIG. 2 is a cross-sectional view schematically showing the display apparatus according to an embodiment of the present disclosure;

FIG. 3 is a cross-sectional view of a pixel and a pad portion PAD of a display apparatus according to a first embodiment of the present disclosure;

FIG. 4 is a cross-sectional view of a pixel and a pad portion PAD of a display apparatus according to a second embodiment of the present disclosure;

FIG. 5 is an enlarged cross-sectional view of the pad portion PAD of the display apparatus according to the first and second embodiments of the present disclosure;

FIG. 6 is a cross-sectional view of a black matrix corresponding to a pad portion PAD according to another embodiment of the present disclosure;

FIG. 7 is a plan view of at least one through hole provided in a black matrix according to the first embodiment of the present disclosure;

FIG. 8 is a plan view of at least one through hole provided in a black matrix according to the second embodiment of the present disclosure;

FIG. 9 is a plan view of at least one through hole provided in a black matrix according to a third embodiment of the present disclosure;

FIG. 10 is a plan view of at least one through hole provided in a black matrix according to a fourth embodiment of the present disclosure; and

FIG. 11 is a cross-sectional view of the black matrix and the pad portion according to an embodiment of the present disclosure.

### DETAILED DESCRIPTION OF THE EMBODIMENTS

Hereinafter, various embodiments of the present disclosure will be described in conjunction with the accompanying drawings. The same reference numerals throughout the present disclosure indicate substantially the same components.

In the following description, if it is determined that a detailed description of technology or configurations related to the present disclosure can unnecessarily obscure the gist of the present disclosure, the detailed description will be omitted. Further, the component names used in the following description are selected in consideration of the ease of writing the present disclosure, and can be different from the component names of the actual product.

The shapes, sizes, ratios, angles, numbers, etc. disclosed in the drawings for explaining various embodiments of the present disclosure are example, and therefore, the present disclosure is not limited to the matters depicted in the drawings. Like reference numerals designate like components throughout the present disclosure.

In addition, when describing the present disclosure, if it is determined that a detailed description of related known technology can unnecessarily obscure the gist of the present disclosure, the detailed description is omitted.

When the terms “include”, “have”, “made of”, etc. mentioned herein are used, other parts can be added unless “only” is used. In the case where a component is expressed in the singular, it includes the case of including the plural unless explicitly stated otherwise.

In interpreting the components included in various embodiments of the present disclosure, even if there is no separate explicit description, it is interpreted as including an error range.

In describing various embodiments of the present disclosure, in the case of describing a positional relationship, for example, when the positional relationship of two parts is described as “on”, “above”, “below”, “next to”, etc., one or more other parts can be located between the two parts unless “immediately” or “directly” is used, and when one part is described as “on” another part, the one part not only can be located above the another part, but also can be located under the another part.

In describing various embodiments of the present disclosure, in the case of describing a temporal relationship, for example, when the temporal causality is described as “after”, “subsequent to”, “then”, “before”, etc., it can also include non-continuous cases unless “immediately” or “directly” is used.

In describing various embodiments of present disclosure, terms such as “first”, “second”, etc. can be used to describe various components, but these terms are only used to distinguish between identical or similar components. Accordingly, unless stated otherwise, a component described as “first” in the present disclosure can be identical to a component described as “second” within the technical spirit of the present disclosure. Further, the term “can” fully encompasses all the meanings and coverages of the term “may” and vice versa.

The features in various embodiments of the present disclosure can be partially or entirely coupled or combined with each other, technically various interlocking and driving are possible, and various embodiments can be implemented independently of each other or together in an association relationship.

Hereinafter, a display apparatus according to embodiments of the present disclosure will be described referring to the drawings. All the components of each display apparatus/device according to all embodiments of the present disclosure are operatively coupled and configured.

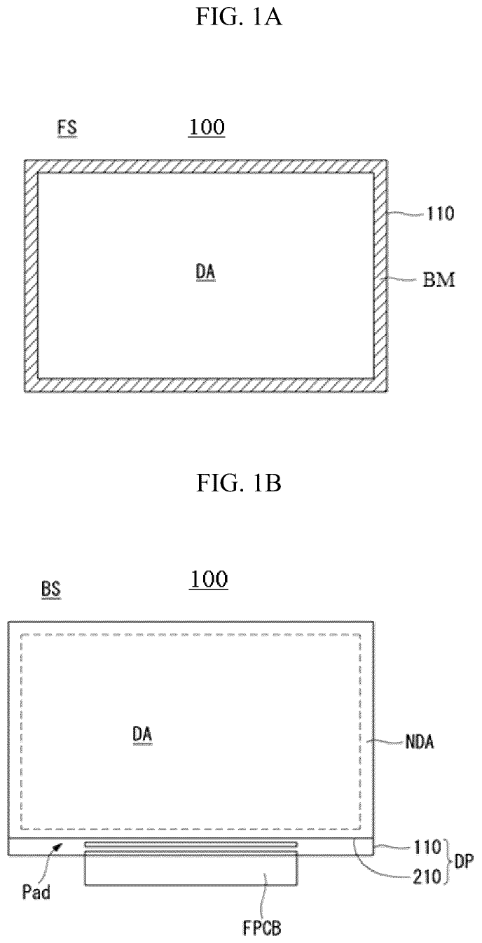

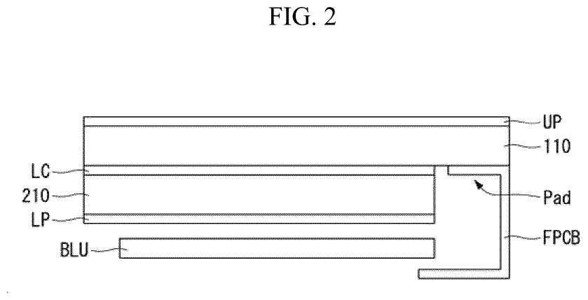

FIGS. 1A and 1B are plan views schematically and respectively showing the front surface and the back surface of a display apparatus according to an embodiment of the present disclosure, and FIG. 2 is a schematic cross-sectional view of the display apparatus according to an embodiment of the present disclosure.

As shown in FIGS. 1A and 1B, a display apparatus 100 according to an embodiment of the present disclosure has a display panel DP in which a thin film transistor array substrate 110 and a color filter array substrate 210 are bonded to each other. In the display panel DP, the thin film transistor array substrate 110 can include a display area DA where an image is displayed and a non-display area NDA where an image is not displayed.

As shown in FIG. 1A, a black matrix BM that blocks light can be located in an area corresponding to the non-display area NDA of the thin film transistor array substrate 110 on the front surface FS of the thin film transistor array substrate 110. As shown in FIG. 1B, a driving portion can be located at the bottom of the back surface BS of the thin film transistor array substrate 110, and a flexible printed circuit board FPCB that transmits various signals such as driving signals, power, etc. can also be located thereat.

Referring to FIG. 2, a more detailed description of the display apparatus is given as follows.

FIG. 2 illustrates a liquid crystal display apparatus including a thin film transistor array substrate 110 and a color filter array substrate 210 to explain the display apparatus according to an embodiment of the present disclosure, but the present disclosure is not limited thereto.

The display apparatus according to an embodiment of the present disclosure can include a display panel DP, which includes a thin film transistor array substrate 110 with a thin film transistor array and driving electrodes formed thereon and a color filter array substrate 210 with a color filter array formed thereon. The thin film transistor array substrate 110 and the color filter array substrate 210 are bonded to each other. A backlight unit BLU can be located to face the lower surface of the display panel DP, namely the back surface of the color filter array substrate 210, in order to supply light to the display panel DP.

The thin film transistor array substrate 110 includes a thin film transistor array. The thin film transistor array can include a plurality of data lines and a plurality of gate lines (or scan lines) intersecting each other to define a pixel area in a matrix form. For example, R, G, and B data voltages can be supplied to the data lines. A gate pulse (or scan pulse) can be supplied to the gate lines (or scan lines).

Each pixel area defined by the data lines and the gate lines intersecting each other can include a thin film transistor, a pixel electrode electrically connected to the thin film transistor, a storage capacitor connected to the pixel electrode to maintain the voltage of the liquid crystal cell, and the like. A common electrode facing the pixel electrode and forming an electric field can be provided on the thin film transistor array substrate 110 along with the pixel electrode to achieve horizontal electric field driving such as IPS (in-plane switching) or FFS (fringe field switching).

The color filter array substrate 210 can include R, G, and B color filters and a black matrix provided therebetween. The color filters function to convert the light emitted from the backlight unit BLU into red, green, and blue colors. Further, a liquid crystal layer LC can be disposed between the thin film transistor array substrate 110 and the color filter array substrate 210.

In addition, an alignment film can be disposed on inner surfaces of the thin film transistor array substrate 110 and the color filter array substrate 210 in contact with the liquid crystal layer LC, and a column spacer can be disposed to maintain a cell gap between adjacent liquid crystal cells. A polarizing plate can be provided on an outer surface of each of the thin film transistor array substrate 110 and the color filter array substrate 210. For example, an upper polarizing plate UP can be provided on the outer surface of the thin film transistor array substrate 110, and a lower polarizing plate LP can be provided on the outer surface of the color filter array substrate 210. Accordingly, an image can be displayed by polarizing the light incident on the display panel DP from the backlight unit BLU and controlling transmission of light through liquid crystals.

The non-display area NDA corresponding to the edge of the thin film transistor array substrate 110 can include a plurality of signal lines configured to apply signals to the display area DA and a pad portion Pad to which a flexible printed circuit board FPCB is connected to apply an external signal from the printed circuit board to the display area DA. The flexible printed circuit board FPCB can be made of a flexible material and can be bent to fit the back surface of the backlight unit BLU. The flexible printed circuit board FPCB can be in contact with a main board mounted on the back surface of the backlight unit BLU. A driving circuit (chip) for driving the gate lines or the data lines can be mounted on the flexible printed circuit board FPCB.

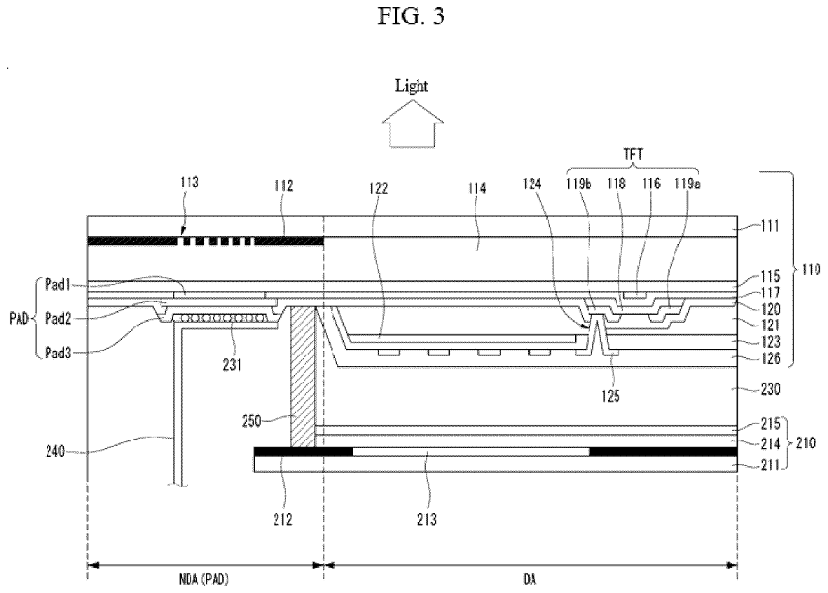

FIG. 3 is a cross-sectional view of a pixel and a pad portion of a display apparatus according to the first embodiment of the present disclosure.

In the display apparatus according to the first embodiment of the present disclosure, as shown in FIG. 3, a black matrix (can also be referred to as a first black matrix) 112 is disposed on a substrate (can also be referred to as a first substrate) 111 of a thin film transistor array substrate 110. Specially, as can be seen from FIG. 3, the black matrix 112 is disposed on a back surface (or lower surface) of the substrate 111, but the present disclosure is not limited thereto. The black matrix 112 can be disposed in an area where a pad portion PAD of a non-display area NDA is to be formed and an area where gate lines and data lines of a display area DA are to be formed. External light can be reflected by the gate lines and data lines disposed in the display area DA, and the reflected light can deteriorate the display quality. In the first embodiment of the present disclosure, the black matrix 112 can be partially disposed in the display area of the substrate 111 of the thin film transistor array substrate 110.

The black matrix 112 disposed at a location corresponding to the pad portion PAD in the non-display area NDA can have at least one through hole 113. The at least one through hole 113 provided in the black matrix 112 is used to conduct pressure mark inspection to be described later. A detailed description thereof will be given later.

The black matrix 112 can be made of a material for shielding light, for example, an organic or inorganic material with low optical density. For example, the black matrix 112 can be made of a resin including a black pigment. The black matrix 112 can be formed of ink including a black pigment, a binder resin, a solvent, and a dispersant. Carbon black can be used as the black pigment, and any pigment can be used without particular limitation so long as it has light shielding properties. Further, examples of the black pigment can include channel black, furnace black, thermal black, lamp black, etc. The black pigment can be included in an amount of 6 to 11 vol % based on the total amount of the ink (can also be referred to as a light shielding pattern ink). When the amount of the black pigment is 6 vol % or more based on the total amount of the ink (in other words, the light shielding pattern ink), light shielding properties can be improved, and when it is 11 vol % or less, inkjet printing can become easy.

The type of binder resin can vary depending on the curing process, and for UV curing, an acrylate-based monomer can be used. Examples of the acrylate-based monomer can include ethylene glycol diacrylate, 1,4-cyclohexanediol diacrylate, trimethylol triacrylate, trimethylol propane triacrylate, pentaerythritol triacrylate, tetraethylene glycol diacrylate, dipentaerythritol triacrylate, dipentaerythritol tetraacrylate, sorbitol triacrylate, sorbitol tetraacrylate, vinyl acetate, triallyl cyanurate, etc. When the binder resin is UV curable, it can further include a photoinitiator. The photoinitiator is a material that triggers polymerization by generating radicals by light, and can be at least one selected from among an acetophenone-based compound, a biimidazole-based compound, a triazine-based compound, and an oxime-based compound, and preferably an oxime-based compound is used. Further, when the binder resin is heat curable, a polyester-based resin, a polyurethane-based resin, an epoxy-based resin, etc. can be used.

Examples of the solvent can include ethyl acetate, n-butyl acetate, isobutyl acetate, ethylene glycol monomethyl ether acetate, ethylene glycol n-butyl ether acetate, diethylene glycol dimethyl ether, diethylene glycol monoethyl ether, dipropylene glycol monomethyl ether acetate, diethylene glycol methyl ethyl ether, diethylene glycol ethyl ether acetate, dipropylene glycol n-butyl ether, tripropylene glycol n-propyl ether, tripropylene glycol methyl ether, propylene glycol methyl ether acetate, propylene glycol diacetate, propylene glycol monomethyl ether, propylene glycol monoethyl ether acetate, cyclohexanone, ethyl 3-methoxypropionate, methyl 3-ethoxypropionate, and ethyl 3-ethoxypropionate.

The dispersant serves to prevent the pigment from being dissolved, and a surfactant can be used. Examples of the dispersant can include silicone-based, fluorine-based, ester-based, cationic, anionic, nonionic, and amphoteric surfactants. As necessary, fillers, hardeners, antioxidants, UV absorbers, etc. can be additionally used. The black matrix 112 can be printed on the substrate using a typical resin application process such as an inkjet printing process, etc.

A first planarization layer 114 can be disposed on the substrate 111 including the black matrix 112. The first planarization layer 114 can include an insulating material. The first planarization layer 114 can include a material having relatively high fluidity. For example, the first planarization layer 114 can include an organic insulating material. For example, the first planarization layer 114 can be formed of an organic insulating material such as photoacryl or benzocyclobutene.

A buffer layer 115 can be disposed on the first planarization layer 114. The buffer layer 115 can be provided in a multilayer structure. The buffer layer 115 is able to prevent moisture penetration from the outside to the inside. The buffer layer 115 can be formed of an inorganic insulating material.

Gate lines and a gate electrode 116 can be disposed on the buffer layer 115 in the display area DA. A first pad Pad1 of the pad portion PAD can be disposed on the buffer layer 115 in the non-display area NDA. The gate lines, the gate electrode 116, and the first pad Pad1 can be disposed on the same layer with the same material. The gate lines, the gate electrode 116, and the first pad Pad1 can be made of a metal material. For example, the gate lines, the gate electrode 116, and the first pad Pad1 can have a monolayer or multilayer structure made of any one selected from among molybdenum (Mo), aluminum (Al), chromium (Cr), gold (Au), titanium (Ti), nickel (Ni), neodymium (Nd), and copper (Cu), or an alloy thereof. However, the present disclosure is not limited thereto.

A gate insulating film 117 can be disposed on entire surface of the buffer layer 115 including the gate lines and the gate electrode 116 except for the first pad Pad1. The gate insulating film 117 can be made of an inorganic insulating film such as a silicon oxide film or a silicon nitride film, and can have a monolayer or multilayer structure.

An active layer 118 can be located in an area corresponding to the gate electrode 116 on the gate insulating film 117 in the display area DA. The active layer 118 can include a semiconductor layer made of polycrystalline silicon, amorphous silicon, or low-temperature polysilicon (LTPS).

A source electrode 119a and a drain electrode 119b can be located on respective sides of the active layer 118 and can be connected to respective sides of the active layer 118. The source electrode 119a and the drain electrode 119b can have a monolayer or multilayer structure made of any one selected from among molybdenum (Mo), aluminum (Al), chromium (Cr), gold (Au), titanium (Ti), nickel (Ni), neodymium (Nd), and copper (Cu), or an alloy thereof. However, the present disclosure is not limited thereto. Accordingly, a thin film transistor TFT including the gate electrode 116, the active layer 118, the source electrode 119a, and the drain electrode 119b can be provided. Herein, a top gate-type thin film transistor in which the gate electrode is located above the active layer has been described exemplarily, but a bottom gate-type thin film transistor in which the gate electrode is located under the active layer can also be applied, and in addition thereto, thin film transistors of various types can be provided.

A second pad Pad2 can be disposed on the first pad Pad1 of the pad portion PAD in the non-display area NDA. For example, the gate insulating film 117 can be selectively removed to expose the first pad Pad1, and the second pad Pad2 can be disposed to be electrically connected to the first pad Pad1. The second pad Pad2 can be disposed on the same layer with the same material as the source electrode 119a and the drain electrode 119b.

Meanwhile, a first protective film 120 can be located on the substrate 111 on which the thin film transistor TFT is disposed. The first protective film 120 can be made of the same material as the gate insulating film 117. The first protective film 120 can be formed of two layers. The drawing shows that the first protective film 120 is formed of one layer, but the present disclosure is not limited thereto.

A second planarization layer 121 made of an organic insulating material such as photoacryl or benzocyclobutene can be located on the first protective film 120. The second planarization layer 121 functions as an insulating film and also serves to flatten the steps formed near the second planarization layer 121. Accordingly, electrodes can be subsequently formed flat on the second planarization layer 121. A common electrode 122 made of a transparent conductive material, such as ITO, IZO, ITZO, etc., can be located on the second planarization layer 121. The common electrode 122 can be patterned in a plate shape for each pixel and can receive a common voltage from a common line.

A second protective film 123 can be located on the common electrode 122 to insulate and protect the common electrode 122. The second protective film 123 can be made of the same material as the first protective film 120. The second protective film 123, the second planarization layer 121, and the first protective film 120 can have a contact hole 124 configured to expose the drain electrode 119b of the thin film transistor TFT.

A pixel electrode 125 connected to the drain electrode 119b can be located on the second protective film 123. The pixel electrode 125 can be made of a transparent conductive material such as ITO, IZO, ITZO, etc.

The pixel electrode 125 is formed in a finger shape or has a plurality of slits, generating a fringe field along with the common electrode 122 when a driving voltage is applied from the drain electrode 119b.

A third pad Pad3 can be disposed on the second pad Pad2 of the pad portion PAD in the non-display area NDA. The third pad Pad3 can be made of the same material as the common electrode 122 or the pixel electrode 125. FIG. 3 shows that the first pad Pad1, the second pad Pad2, and the third pad Pad3 are stacked in the pad portion PAD in the non-display area NDA, but the present disclosure is not limited thereto. Either the first pad Pad1 or the second pad Pad2 can be omitted.

A first alignment film 126 for aligning liquid crystals can be located on the pixel electrode 125. Accordingly, a thin film transistor array substrate 110 including the thin film transistor, the pixel electrode, and the common electrode is provided.

Meanwhile, a color filter array substrate 210 is formed. For example, a black matrix (can also be referred to as a second black matrix) 212 can be disposed on a substrate (can also be referred to as a second substrate) 211 constituting the color filter array substrate 210 corresponding to the boundary of each pixel and the thin film transistor TFT. The black matrix 212 can also have the same characteristics as the black matrix 112. Red, green, and blue color filters 213 can be located in each pixel area partitioned by the black matrix 212. An overcoat layer 214 can be located on the black matrix 212 and the color filters 213. A second alignment film 215 for aligning liquid crystals can be located on the overcoat layer 214.

The thin film transistor array substrate 110 and the color filter array substrate 210 thus configured are bonded by a sealant 250. For example, the thin film transistor array substrate 110 and the color filter array substrate 210 are bonded by the sealant 250 so that a certain gap is present between the thin film transistor array substrate 110 and the color filter array substrate 210 and the first alignment film 126 and the second alignment film 215 face each other. The sealant 250 can be located in the non-display area NDA.

Further, a liquid crystal layer 230 can be interposed between the thin film transistor array substrate 110 and the color filter array substrate 210 bonded as described above.

Meanwhile, a flexible printed circuit board (FPCB) 240 can be attached to the pad portion PAD in the non-display area NDA by a TAB (tape automated bonding) process using an anisotropic conductive film (ACF) 231. For example, an anisotropic conductive film (ACF) 231 is located on the third pad Pad3 of the pad portion PAD in the non-display area NDA, and a flexible printed circuit board (FPCB) 240 is located on the anisotropic conductive film (ACF) 231 and then pressed, so that the third pad Pad3 and the flexible printed circuit board 240 are electrically connected to each other by conductive balls in the anisotropic conductive film (ACF) 231.

The flexible printed circuit board (FPCB) 240 can be made of a flexible material and can have signal lines embedded therein and a pad portion exposed at one side. A driving circuit (chip) for driving gate lines or data lines can be mounted on the flexible printed circuit board (FPCB) 240.

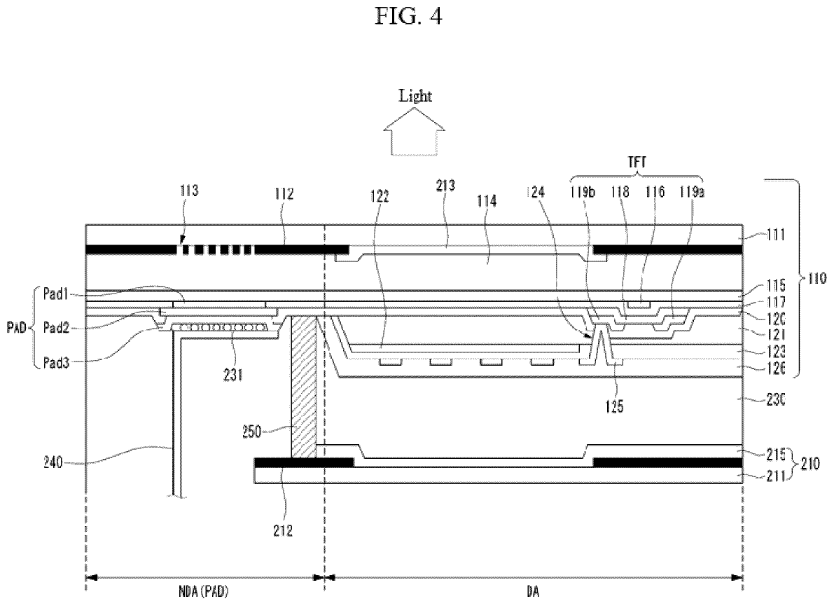

FIG. 4 is a cross-sectional view of a pixel and a pad portion of a display apparatus according to the second embodiment of the present disclosure.

In the display apparatus according to the second embodiment of the present disclosure, as shown in FIG. 4, a black matrix 112 is disposed on a substrate 111 of a thin film transistor array substrate 110. The black matrix 112 can be disposed at a boundary of a pixel area in the display area DA and an area where a pad portion in the non-display area NDA is to be formed. The boundary of the pixel area can include an area where gate lines, data lines, and thin film transistors are to be formed. External light can be reflected by the gate lines and data lines disposed in the display area DA, and the reflected light can deteriorate the display quality. As mentioned above and can be seen from FIG. 4, in the second embodiment of the present disclosure, the black matrix 112 can be partially disposed in the display area of the substrate 111 of the thin film transistor array substrate 110.

The black matrix 112 disposed at a location corresponding to the pad portion PAD in the non-display area NDA can have at least one through hole 113. The at least one through hole 113 provided in the black matrix 112 is used to perform pressure mark inspection to be described later, and a detailed description thereof will be given later.

The black matrix 112 can be made of a material for shielding light and can include an organic or inorganic material with low optical density. A specific embodiment of the black matrix 112 is as described in the display apparatus according to the first embodiment of the present disclosure shown in FIG. 3. Hence, the specific embodiment of the black matrix 112 is omitted.

A color filter (can also be referred to as a color filter layer) 213 can be disposed on the substrate 111 between adjacent black matrices 112 in the display area DA.

A first planarization layer 114 can be disposed on the substrate 111 including the black matrix 112 and the color filter 213. A buffer layer 115 can be disposed on the first planarization layer 114. The materials and configurations of the first planarization layer 114 and the buffer layer 115 are the same as those described in the first embodiment of the present disclosure (FIG. 3), so a description thereof is omitted.

In addition, the configuration of the thin film transistor array formed on the buffer layer 115 in the display area DA and the buffer layer 115 in the non-display area is the same as that described in the first embodiment of the present disclosure (FIG. 3), so a description thereof is omitted.

Meanwhile, a color filter array substrate 210 is formed. For example, a black matrix 212 can be disposed on a substrate 211 constituting the color filter array substrate 210 corresponding to the boundary of each pixel and the thin film transistor TFT. The black matrix 212 can also have the same characteristics as the black matrix 112. An overcoat layer can be located on the substrate 211 including the black matrix 212. A second alignment film 215 for aligning liquid crystals can be located on the overcoat layer. Here, the overcoat layer can be omitted. FIG. 4 shows that the overcoat layer is omitted. In addition, a color filter can be located on the substrate 211 in each pixel area partitioned by the black matrix 212 and can be omitted depending on the need. FIG. 4 shows that the color filter is omitted (instead, as mentioned above, a color filter 213 is disposed on the substrate 111).

As described in the first embodiment of the present disclosure (FIG. 3), the thin film transistor array substrate 110 and the color filter array substrate 210 are bonded by a sealant 250, and a liquid crystal layer 230 can be interposed between the thin film transistor array substrate 110 and the color filter array substrate 210, which are bonded. The specific configuration thereof is omitted as it is the same as that described in the first embodiment of the present disclosure (FIG. 3).

In addition, the configuration in which a flexible printed circuit board (FPCB) 240 is attached to the pad portion PAD in the non-display area NDA by a TAB (tape automated bonding) process using an anisotropic conductive film (ACF) 231 is also omitted as it is the same as that described in the first embodiment of the present disclosure (FIG. 3).

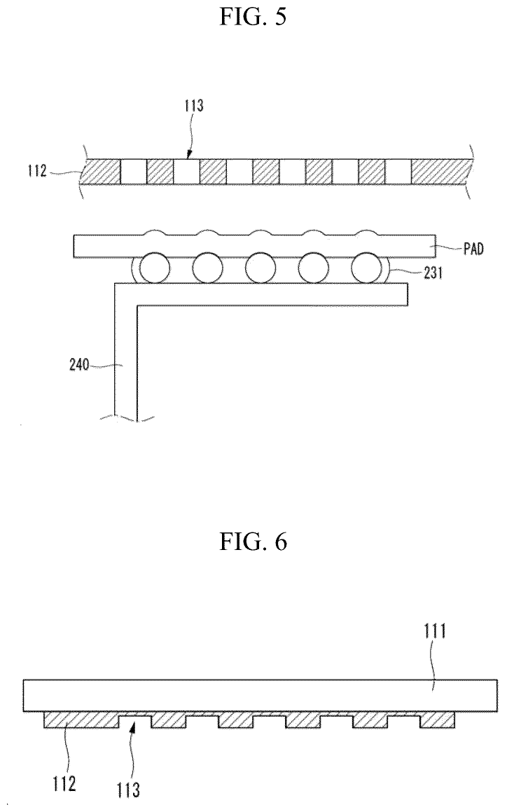

FIG. 5 is an enlarged cross-sectional view of the pad portion PAD of the display apparatus according to the first and second embodiments of the present disclosure.

As described above, when the flexible printed circuit board (FPCB) 240 is pressed against the pad portion PAD by a TAB process using an anisotropic conductive film (ACF) 231, the pad portion PAD and the flexible printed circuit board (FPCB) 240 are electrically connected to each other by conductive balls in the anisotropic conductive film (ACF) 231.

In this way, when the pad portion PAD and the flexible printed circuit board (FPCB) 240 are normally connected by the conductive balls, pressure marks corresponding to the conductive balls are generated on the pad portion PAD, as shown in FIG. 5.

Accordingly, by observing the pressure marks via the at least one through hole 113 formed in the black matrix 112 using a microscope or camera, it is possible to determine whether the flexible printed circuit board (FPCB) 240 is normally connected to the pad portion PAD.

Meanwhile, in the display apparatus of the first and second embodiments of the present disclosure, formation of at least one through hole 113 in the black matrix 112 of the pad portion PAD in the non-display area NDA is described, but the present disclosure is not limited thereto.

FIG. 6 is a cross-sectional view of a black matrix corresponding to a pad portion PAD according to another embodiment of the present disclosure.

As shown in FIG. 6, pressure mark inspection can be performed even when allowing a material for the black matrix 112 to remain thinly on an area corresponding to the at least one through hole 113 as mentioned above using a halftone mask during patterning of the black matrix 112. For example, such a material can be left behind to be thinner in a thickness on the area corresponding to the at least one through hole 113 as mentioned above than other areas of the black matrix 112. In other words, the black matrix 112 can have at least one area with a reduced thickness, which can be used for pressure mark inspection.

In addition, the at least one through hole 113 formed in the black matrix 112 can be provided in various shapes.

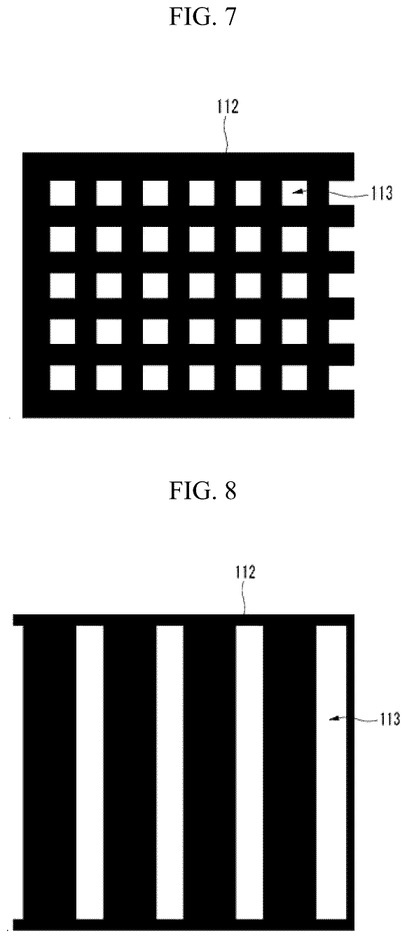

FIG. 7 is a plan view of at least one through hole provided in a black matrix according to the first embodiment of the present disclosure.

As shown in FIG. 7, a plurality of square-shaped through holes 113 can be provided in a matrix form in the black matrix 112.

FIG. 8 is a plan view of at least one through hole provided in a black matrix according to the second embodiment of the present disclosure.

As shown in FIG. 8, a plurality of stripe-shaped through holes 113 can be provided in the black matrix 112.

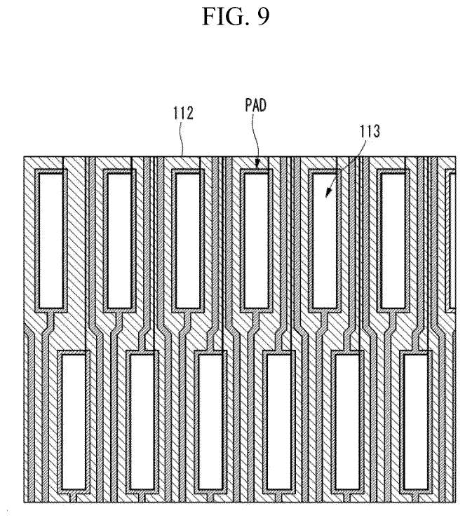

FIG. 9 is a plan view of at least one through hole provided in a black matrix according to a third embodiment of the present disclosure.

As shown in FIG. 9, a pad portion PAD has a plurality of pads to be provided in two stages (but not limited thereto, in other words, the plurality of pads can be provided in at least two stages, for example, three or more stages) in the non-display area NDA, a black matrix 112 can be disposed to surround the pad portion PAD, and a plurality of through holes 113 can be provided in the black matrix 112 such that the edge of each of the plurality of pads is covered by the black matrix 112 and the center of each of the plurality of pad is exposed by the through holes 113. The third embodiment of the present disclosure described in FIG. 9 can be applied to a pad portion having a COG (chip on glass) structure.

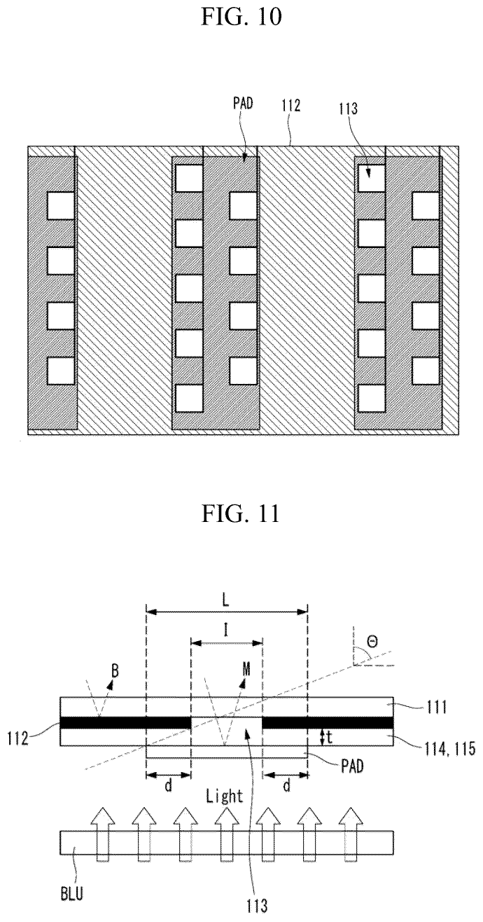

FIG. 10 is a plan view of at least one through hole provided in a black matrix according to a fourth embodiment of the present disclosure.

As shown in FIG. 10, a pad portions PAD has a plurality of pads. A black matrix 112 can be disposed to surround the pad portion PAD, and a plurality of through holes 113 can be provided in one or two rows in the black matrix 112 (for example, at a location corresponding to each of the plurality of pads) such that the edge of each of the plurality of pads is partially exposed. The fourth embodiment of the present disclosure described in FIG. 10 can be applied to a pad portion having a FOG (film on glass) structure.

Meanwhile, in order to perform pressure mark inspection on the pad portion PAD, at least one through hole (for example, a plurality of through holes) 113 is formed in the black matrix 112. However, if light from the backlight unit BLU is emitted to the outside via the through holes 113 formed in the black matrix 112, defects can occur. Hence, the through holes 113 formed in the black matrix 112 have to be configured to block a light leakage phenomenon.

FIG. 11 is a cross-sectional view of a black matrix and a pad portion according to an embodiment of the present disclosure.

As shown in FIGS. 3 and 4, the black matrix 112 is located on the back surface of the substrate 111 in the non-display area NDA, and the first planarization layer 114 and the buffer layer 115 are disposed between the black matrix 112 and the pad portion PAD. The black matrix 112 has at least one through hole 113 (for example, at a location corresponding to the pad portion PAD).

Here, as shown in FIG. 11, when viewed in a cross-sectional view of the black matrix 112 and the pad portion PAD, a length of the pad portion PAD is denoted as “L”, a length of an area of the black matrix 112 in which the at least one through hole 113 is formed (for example, when the at least one through hole 113 is a single through hole, a length of the single through hole formed in the black matrix 112) is denoted as “1”, the total thickness of the first planarization layer 114 and the buffer layer 115 is denoted as “t”, and a length of each of the overlap areas of the black matrix 112 and the pad portion PAD is denoted as “d”.

Similarly, as shown in FIG. 11, it is assumed that an angle between a line connecting an end (for example, an upper end) of the pad portion PAD and an end (for example, a lower end) of the area of the black matrix 112 in which the at least one through hole is formed and the vertical direction is denoted as “0”, the external light reflectance of the black matrix 112 is denoted as “B”, and the external light reflectance of the pad portion PAD is denoted as “M”. The external light reflectance B of the black matrix 112 and the external light reflectance M of the pad portion PAD are values determined by measurement or simulation.

Under such conditions, basic conditions for preventing light leakage are that the length L of the pad portion PAD has to be greater than the length l of the area of the black matrix 112 in which the at least one through hole 113 is formed (l<L), and a length d of each of the overlap areas of the black matrix 112 and the pad portion PAD has to be greater than the total thickness t of the first planarization layer 114 and the buffer layer 115 (t<d).

Further, the conditions for preventing light leakage in the viewing angle range have to satisfy the following relationship: d>t*tan θ_max, wherein θ_max corresponds to a maximum allowable viewing angle.

In general, the viewing angle of the general use range is −45° to 45°, and in this case, a corresponding θ_max can be considered to be equal to 45°, and the conditions for preventing light leakage in the viewing angle of the general use range (−45° to) 45° are shown in [Table 1] below. It should be noted that in Table 1 (and Table 2, which will be described later), d_min represents the minimum value of the length d required for preventing light leakage.

TABLE 1

| Θ [°] | t [μm] | d_min [μm] |
|---|---|---|
| −45~45 | 0.5 | 0.5 |
| −45~45 | 1.0 | 1.0 |
| −45~45 | 2.0 | 2.0 |
| −45~45 | 3.0 | 3.0 |

In addition, due to the characteristics of the product, the limit viewing angle can be −80° to 80°, and in this case, a corresponding θ_max can be considered to be equal to 80°, and the conditions for preventing light leakage at the limit viewing angle (−80° to) 80° are shown in [Table 2] below.

TABLE 2

| Θ [°] | t [μm] | d_min [μm] |
|---|---|---|
| −80~80 | 0.5 | 2.9 |
| −80~80 | 1.0 | 5.7 |
| −80~80 | 2.0 | 11.4 |
| −80~80 | 3.0 | 17.1 |

Meanwhile, an average reflectance R depending on the length L of the pad portion PAD can be defined as represented in [Mathematical Formula 1] below.

$$R = B + ( M - B ) \cdot \frac{l}{L} \qquad [ Mathematical Formula 1 ]$$

When the average reflectance R depending on the length L of the pad portion PAD is defined as n times (n>1) the reflectance of the surrounding black matrix (R=n*B), the aperture ratio (l/L) to achieve the target value of the average reflectance R depending on the length L of the pad portion PAD can be derived as represented in [Mathematical Formula 2] below.

$$( \frac{M}{B} - 1 ) \cdot \frac{l}{L} = n - 1 \qquad [ Mathematical Formula 2 ]$$

For example, based on simulation results of the reflectance B (=4.61%) of the black matrix 112 and the reflectance M (=15.19%) of the pad portion PAD, if the average reflectance R of the area of forming the through hole 113 in the black matrix 112 is set to 9.22% (n=2), which is twice that of the black matrix 112, the aperture ratio (l/L) needs to be 43.6% by [Mathematical Formula 2] (n=1.5→1/L=21.8%, n=1.2→1/L=8.7%).

Conversely, it is also possible to derive the average reflectance depending on the aperture ratio, resulting in l/L=10%→n=1.23 (R=5.67%), l/L=20%→n=1.46 (R=6.73%), and l/L=30%→n=1.69 (R=7.78%).

As is apparent from the foregoing, according to aspects of the present disclosure, a black matrix disposed to cover a pad portion includes at least one through hole or at least one area with a reduced thickness configured to inspect a pressure mark caused by pressing a flexible printed circuit board against a pad portion. Therefore, pressure mark inspection is possible even if on a liquid crystal display panel having a TOB or TOC structure.

According to aspects of the present disclosure, by controlling conditions such as the length of the pad portion, the length of an area of the black matrix in which the at least one through hole is formed, the total thickness of a first planarization layer and a buffer layer, the overlap length of the black matrix and the pad portion, the angle between the line connecting an end of the pad portion and an end of at least one through hole and the vertical direction, the external light reflectance of the black matrix, the external light reflectance of the pad portion, and the like, it is possible to prevent light leakage from the backlight unit depending on the viewing angle.

Further, according to aspects of the present disclosure, it is possible to derive an average reflectance depending on the aperture ratio of the at least one through hole.

The effects according to the embodiments of the present disclosure are not limited to the foregoing, and more diverse effects are included in the present disclosure.

The present disclosure is not limited to the aforementioned embodiments and the attached drawings, and it will be apparent to those skilled in the art to which the present disclosure pertains that various substitutions, modifications, and changes are possible within a scope that does not depart from the technical spirit of the present disclosure.

What is claimed is:

1. A display apparatus, comprising:
a substrate having a display area and a non-display area and comprising a pad portion provided on a back surface of the substrate in the non-display area;
a black matrix disposed on the back surface of the substrate in the non-display area to cover the pad portion; and
a flexible printed circuit board pressed against the pad portion,
wherein the black matrix comprises at least one through hole or at least one area with a reduced thickness configured to inspect a pressure mark caused by pressing the flexible printed circuit board against the pad portion.

2. The display apparatus according to claim 1, wherein the at least one through hole is a plurality of through holes each having a square shape or a stripe shape.

3. The display apparatus according to claim 1, wherein the pad portion of the substrate has a plurality of pads provided in at least two stages, and
wherein the at least one through hole is positioned at a center area of each of the plurality of pads.

4. The display apparatus according to claim 3, wherein the pad portion of the substrate has a chip on glass structure.

5. The display apparatus according to claim 4, wherein the black matrix is disposed to surround the pad portion, and
wherein a plurality of through holes are provided in the black matrix so that an edge of each of the plurality of pads is covered by the black matrix and the center area of each of the plurality of pads is exposed by the plurality of through holes.

6. The display apparatus according to claim 1, wherein the pad portion of the substrate has a plurality of pads, and
wherein the at least one through hole is a plurality of through holes provided in one or two rows so that an edge of each of the plurality of pads is partially exposed.

7. The display apparatus according to claim 6, wherein the pad portion of the substrate has a film on glass structure.

8. The display apparatus according to claim 1, wherein the display apparatus further comprises a first planarization layer disposed on the substrate including the black matrix, and a buffer layer disposed on the first planarization layer, and
wherein when viewed in a cross-sectional view of the black matrix and the pad portion of the substrate, a length L of the pad portion is configured to be greater than a length l of an area of the black matrix in which the at least one through hole is formed, and a length d of each of overlap areas of the black matrix and the pad portion is configured to be greater than a total thickness t of the first planarization layer and the buffer layer.

9. The display apparatus according to claim 8, wherein when an angle between a line connecting an end of the pad portion and an end of the area of the black matrix in which the at least one through hole is formed and a vertical direction is denoted as θ,
the following relationship: d>t*tan θ_max is satisfied, where θ_max corresponds to a maximum allowable viewing angle.

10. The display apparatus according to claim 9, wherein θ_max is set to be equal to 45° or 80°.

11. The display apparatus according to claim 1, wherein the black matrix comprises ink including a black pigment, a binder resin, a solvent, and a dispersant, and
wherein the black pigment included in the ink is in an amount of 6 to 11 vol % based on a total amount of the ink.

12. A display apparatus, comprising:
a first substrate having a display area and a non-display area defined thereon;
a first black matrix disposed on the first substrate in the non-display area;
a first planarization layer disposed on the first substrate including the first black matrix;
a thin film transistor disposed on the first planarization layer in the display area;
a pad portion disposed on the first planarization layer in the non-display area so as to be covered by the black matrix;
a second planarization layer disposed on the first substrate on which the thin film transistor in the display area is disposed;
a pixel electrode disposed on the second planarization layer and electrically connected to the thin film transistor;
a first alignment film disposed on the pixel electrode;
a second black matrix and a color filter disposed on a second substrate;
a second alignment film disposed on the second substrate on which the second black matrix and the color filter are disposed;
a sealant configured to bond the first substrate and the second substrate so that the first alignment film and the second alignment film face each other;
a liquid crystal layer interposed between the first substrate and the second substrate that are configured to be bonded; and
a flexible printed circuit board attached to the pad portion using a conductive film,
wherein the first black matrix has at least one through hole or at least one area with a reduced thickness formed at a location corresponding to the pad portion to inspect a pressed mark caused by pressing of the flexible printed circuit board against the pad portion.

13. The display apparatus according to claim 12, wherein the at least one through hole is a plurality of through holes each having a square shape or a stripe shape.

14. The display apparatus according to claim 12, wherein the pad portion has a plurality of pads provided in at least two stages, and an edge of each of the plurality of pads is covered by the first black matrix and a center of each of the plurality of pads is exposed by the at least one through hole.

15. The display apparatus according to claim 14, wherein the pad portion has a chip on glass structure.

16. The display apparatus according to claim 12, wherein the pad portion has a plurality of pads, and
wherein the at least one through hole is a plurality of through holes provided in one or two rows so that an edge of each of the plurality of pads is partially exposed.

17. The display apparatus according to claim 16, wherein the pad portion has a film on glass structure.

18. A display apparatus, comprising:
a first substrate having a display area and a non-display area defined thereon;
a black matrix disposed on the first substrate in the non-display area and the display area;
a color filter disposed on the first substrate in the display area;
a first planarization layer disposed on the first substrate including the black matrix and the color filter;
a thin film transistor disposed on the first planarization layer in the display area;
a pad portion disposed on the first planarization layer in the non-display area so as to be covered by the black matrix;
a second planarization layer disposed on the first substrate on which the thin film transistor in the display area is disposed;
a pixel electrode disposed on the second planarization layer and electrically connected to the thin film transistor;
a first alignment film disposed on the pixel electrode;
a second alignment film disposed on a second substrate;
a sealant configured to bond the first substrate and the second substrate so that the first alignment film and the second alignment film face each other;
a liquid crystal layer interposed between the first substrate and the second substrate that are configured to be bonded; and
a flexible printed circuit board attached to the pad portion using a conductive film,
wherein the black matrix has at least one through hole or at least one area with a reduced thickness formed at a location corresponding to the pad portion to inspect a pressed mark caused by pressing of the flexible printed circuit board against the pad portion.

19. The display apparatus according to claim 18, wherein the at least one through hole is a plurality of through holes each having a square shape or a stripe shape.

20. The display apparatus according to claim 18, wherein the pad portion has a plurality of pads provided in at least two stages, and an edge of each of the plurality of pads is covered by the black matrix and a center of each of the plurality of pads is exposed by the at least one through hole.

21. The display apparatus according to claim 20, wherein the pad portion has a chip on glass structure.

22. The display apparatus according to claim 18, wherein the pad portion has a plurality of pads, and
wherein the at least one through hole is a plurality of through holes provided in one or two rows so that an edge of each of the plurality of pads is partially exposed.

23. The display apparatus according to claim 22, wherein the pad portion has a film on glass structure.
